(19) United States
(12) Patent Application Publication
(10) Pub. No.: US 2020/0324456 A1
(43) Pub. Date: Oct. 15, 2020

(54) BLOW MOLDED ARTICLE WITH VISUAL EFFECTS

(71) Applicant: The Procter & Gamble Company, Cincinnati, OH (US)

(72) Inventors: Marc Andrew Mamak, Mason, OH (US); Mark Lewis Agerton, Mason, OH (US); Amanda Susan Ehrhardt, Cincinnati, OH (US); Bradley Scott Neufarth, Loveland, OH (US); Andrew Scott Horton, Middletown, OH (US)

(21) Appl. No.: 16/845,295

(22) Filed: Apr. 10, 2020

Related U.S. Application Data
(60) Provisional application No. 62/832,342, filed on Apr. 11, 2019.

(51) Int. Cl. B29C 49/22; B29C 49/00

(52) U.S. Cl. CPC B29C 49/22; B29L 2031/7158; B29C 49/0005

(57) ABSTRACT

An article with a hollow body defined by a wall with an inner surface and an outer surface. The wall is comprised of 2 or more layers including a first skin layer with effect pigments and an opaque core. In some examples, the effect pigment can be a special effect pigment adapted to produce at least one interference color.

### FIELD OF THE INVENTION

The present invention relates to blow molded articles with a more intense (bright), high chroma (pure color), and/or color variable/goniochromatic effects. The invention relates also to preforms for making such articles and to methods for making these preforms and articles.

### BACKGROUND OF THE INVENTION

Consumers want to purchase articles, particularly hair and beauty products in blow molded containers, that grab their attention by having a unique and/or premium appearance at the store shelf and/or webpage/app.

To make eye-catching articles that connotate luxury and quality, it can be desirable for the article to have more intense (bright), chromatic (pure color), and/or goniochromatic effects while maintaining basic features of the molded container such as high opacity to protect the product from UV and visible light. The variation of reflection intensity, chromaticity, and color across the blow molded container due to regions of different curvature can be eye catching to the consumer as they pass by and view the products on the store shelf.

In single layer blow molded articles with effect pigments, the single layer does not allow for easy reemission of reflected colors (i.e. a large amount of reflected color is absorbed by the materials in the article's wall before it exits the surface) causing the intensity, chroma, and goniochromatic effect to be poor. One reason for this is because secondary pigments such as opacifiers (e.g. TiO₂, carbon black) or toners (e.g. transparent organic pigments) are co-incorporated with the effect pigment such that the effect pigment and secondary pigment are randomly dispersed throughout the thickness of the single layer. The presence of secondary pigments within the same layer as the effect pigment can absorb and/or scatter light reflected from the effect pigments, thereby diminishing the total amount of reflected light. Also, it can be expensive to incorporate effect pigments into large scale blow molded articles because the weight percent loading of pigment particles required to achieve the desired optical effect is difficult to afford within the context of high-volume disposable packaging. Once dispersed within a blow molded article, the articles can generally have poor gloss, high haze, poor chroma, and poor color flop effects which diminishes the optical appearance benefits of the pigments.

In multilayer blow molded articles with effect pigment in the core and transparent skin layers, the effect pigment, can transmit complementary colors along with others and eventually the transmitted wavelengths will re-emit from the surface of the article due to multiple scattering. Therefore, the article will have a weak intensity, chroma, and/or goniochromatic effects.

As such, there remains a need for a multilayer blow molded article with effect pigments capable of producing a more intense reflection (bright), high chroma (pure color), and/or goniochromatic effect.

### SUMMARY OF THE INVENTION

A blow molded multilayer article comprising: a hollow body defined by a wall comprising an inner surface and an outer surface, the wall being formed in at least one region by 3 or more layers comprising: a first skin layer and a second skin layer comprising an effect pigment and a first thermoplastic resin, wherein the first skin layer comprises the outer surface of the wall in the region and the second skin layer comprises the inner surface of the wall in the region; a core comprising a total luminous transmittance of less than 50% is sandwiched between the two skin layers, wherein the core comprises a second thermoplastic resin; wherein the first thermoplastic resin and the second thermoplastic resin are the same or different.

An article comprising: a hollow body defined by a wall comprising an inner surface and an outer surface, the wall being formed in at least one region by 2 or more layers comprising: a skin layer comprising a special effect pigment adapted to produce at least one interference color and a thermoplastic resin, wherein the skin layer comprises the outer surface of the wall in the region; and a core comprising a total luminous transmittance of less than 30% adjacent to the skin layers, wherein the core comprises a second thermoplastic resin and is substantially free of effect pigment; wherein the first thermoplastic resin and the second thermoplastic resin are the same or different.

### BRIEF DESCRIPTION OF THE DRAWINGS

The patent or application file contains at least one photograph executed in color. Copies of this patent or patent application publication with color photograph(s) will be provided by the Office upon request and payment of the necessary fee.

While the specification concludes with claims particularly pointing out and distinctly claiming the subject matter of the present invention, it is believed that the invention can be more readily understood from the following description taken in connection with the accompanying drawings, in which:

FIG. 1 represents schematically a bottle showing an enlarged schematic cross-section thereof with skin layers A and core layer B;

FIG. 2A shows a micro-CT rendered image of a cross-sectional view of the panel wall from monolayer PET bottle with effect pigments;

FIG. 2B shows a micro-CT rendered image of a cross-sectional view of the panel wall from multilayer PET bottle with effect pigments in the skin layers;

FIG. 3 describes the measurement naming system used to determine the ΔE, a*, b*, C*, and h° at different viewing angles when illuminated at 45°;

FIG. 4A is a trilayer bottle with effect pigment in the skin layers and opaque black pigment in the core;

FIG. 4B is a magnified view of the outer surface of the wall of the trilayer bottle of FIG. 4A;

FIG. 4C is a monolayer bottle where the opaque black pigment and the special effect piment are co-mixed;

FIG. 4D is a is a magnified view of the outer surface of the wall of the monolayer bottle of FIG. 4C;

FIG. 4E shows a side-by-side photo comparison of the trilayer bottle in FIG. 4A and the monolayer bottle in FIG. 4C;

FIG. 4F is a graph showing a* and b* values intensity vs. observation angle for the bottles in FIGS. 4A and 4C;

FIG. 5A is a trilayer bottle with effect pigment in the skin layers and white pigment in the core;

FIG. 5B is a magnified view of the outer surface of the wall of the trilayer bottle of FIG. 5A;

FIG. 5C is a monolayer bottle where the opaque black pigment and the special effect piment are co-mixed;

FIG. 5D is a is a magnified view of the outer surface of the wall of the monolayer bottle of FIG. 5C;

FIG. 5E shows a side-by-side photo comparison of the trilayer bottle in FIG. 5A and the monolayer bottle in FIG. 5C;

FIG. 5F is a graph showing a* and b* values vs. observation angle for the bottles in FIGS. 5A and 5C.

### DETAILED DESCRIPTION OF THE INVENTION

While the specification concludes with claims particularly pointing out and distinctly claiming the invention, it is believed that the present disclosure will be better understood from the following description.

As used herein, “article” refers to an individual blow molded hollow object for consumer usage, e.g. a container suitable for containing compositions. Non-limiting examples can include a bottle, a jar, a cup, a cap, a vial, a tottle, and the like. The article can be used in storage, packaging, transport/shipping, and/or for dispensing compositions container therein. Non-limiting volumes containable within the container are from about 10 mL to about 1000 mL, about 100 ml to about 900 mL, from about 200 mL to about 860 mL, from about 260 mL to about 760 mL, from about 280 mL to about 720 mL, from about 350 mL to about 500 mL. Alternatively, the container can have a volume up to 5 L or up to 20 L.

The compositions contained in the article may be any of a variety of compositions and including detergents (such as laundry or dishwashing detergents), fabric softeners and fragrance enhancers (such as Downy® Fresh Protect) food products including but not limited to liquid beverages and snacks, paper products (e.g., tissues, wipes), beauty care compositions (e.g., cosmetics, lotions, shampoos, conditioners, hair styling, deodorants and antiperspirants, and personal cleansing including washing, cleaning, cleansing, and/or exfoliating of the skin, including the face, hands, scalp, and body), oral care products (e.g., tooth paste, mouth wash, dental floss), medicines (antipyretics, analgesics, nasal decongestants, antihistamines, cough suppressants, supplements, anti-diarrheal, proton pump inhibitor and other heartburn remedies, anti-nausea, etc.) and the like. The compositions can include many forms, non-limiting examples of forms can include liquids, gels, powders, beads, solid bars, pacs (e.g. Tide PODS®), flakes, paste, tablets, capsules, ointments, filaments, fibers, and/or sheets (including paper sheets like toilet paper, facial tissues, and wipes).

The article can be a bottle for holding a product, for instance a liquid product like shampoo and/or conditioner and/or body wash.

As used herein, the term “blow molding” refers to a manufacturing process by which hollow plastic articles containing cavities, suitable to accommodate compositions are formed. Generally, there are three main types of blow molding: extrusion blow molding (EBM), injection blow molding (IBM) and molding injection stretch blow molding (ISBM).

As used herein, the term “color” includes any color, such as, e.g., white, black, red, orange, yellow, green, blue, violet, brown, and/or any other color, or declinations thereof.

As used herein, “opaque” means that layer has total luminous transmittance of less than 50%. The total luminous transmittance is measured in accordance with the Total Luminous Transmittance test method described hereafter.

As used herein, “preform” is a unit that has been subjected to preliminary, usually incomplete, shaping or molding, and is normally further processed to form an article. The preform is usually approximately “test-tube” shaped.

As used herein, “substantially free” means less than 3%, alternatively less than 2%, alternatively less than 1%, alternatively less than 0.5%, alternatively less than 0.25%, alternatively less than 0.1%, alternatively less than 0.05%, alternatively less than 0.01%, alternatively less than 0.001%, and/or alternatively free of. As used herein, “free of” means 0%.

As used herein, the terms “include,” “includes,” and “including,” are meant to be non-limiting and are understood to mean “comprise,” “comprises,” and “comprising,” respectively.

All percentages, parts and ratios are based upon the total weight of the compositions of the present invention, unless otherwise specified. All such weights as they pertain to listed ingredients are based on the active level and, therefore, do not include carriers or by-products that may be included in commercially available materials.

Unless otherwise noted, all component or composition levels are in reference to the active portion of that component or composition, and are exclusive of impurities, for example, residual solvents or by-products, which may be present in commercially available sources of such components or compositions.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Where amount ranges are given, these are to be understood as being the total amount of said ingredient in the composition, or where more than one species fall within the scope of the ingredient definition, the total amount of all ingredients fitting that definition, in the composition.

The eye-catching articles with superior intensity, higher chroma, and/or a goniochromatic effect can be blow molded having a hollow body, such as containers and bottles, and can be made by blow molding, in particular, injection stretch blow molding (ISBM).

The blow molded articles can contain effect pigments. As used herein, “effect pigment” means one of two main classes of pigments “metal effect pigments” and “special effect pigments.” Metal effect pigments consist of only metallic particles. They create a metal-like luster by reflection of light at the surface of the metal platelets when having parallel alignment in their application system. The incident light ray is fully reflected at the surface of the metal platelet without any transmitted component.

Special effect pigments include all other platelet-like effect pigments which cannot be classified as “metal effect pigments”. These are typically based on a substrate which has platelet shaped crystals (or particles) such as mica, (natural or synthetic) borosilicate glass, alumina flakes, silica flakes. These platelet shaped particles are typically coated with oxides like titanium dioxide, iron oxide, silicon dioxide, tin oxide, or combinations thereof.

Special effect pigments can be transparent/semi-transparent which are based on coating one or more layers onto a platelet substrate such as mica, silicon dioxide, borosilicate glass, alumina, or the like. The layers coating the platelet are often oxides like titanium dioxide, iron oxide, silicon dioxide, or combinations thereof. Effect pigments based on this structure can reflect a portion of the incident light while allowing the complementary portion of light spectrum to be transmitted through the coated platelet. The interference color effects due to reflected light from semi-transparent effect pigments can be best observed when viewed over a dark background since the background can absorb the transmitted complementary light spectrum along with any other incident light passing through or around the coated platelets. With a white or light background, the complementary transmitted light spectrum can diffusely scatter and reemerge to the observer, thus resulting in a less chromatic response.

In one example, effect pigments can be titanium dioxide coated onto mica platelets, which can achieve a silver pearl luster at a thickness of 40-60 nm. When the titanium dioxide is a thicker layer, a series of interference colors can be achieved due to the refractive index difference between the layer and the mica platelet. For instance, as the titanium dioxide layer increases from 60 to 160 nm, the interference colors progress from yellow to red to blue to green. Due to the nature of the pigments, the interference color can only be observed at a special angle relative to the observer, incident light and platelet surface. In other words, for special effect pigments based on titanium dioxide/mica having parallel alignment in their application system the interference color will appear a lustrous color near one angle, and transparent such that the surrounding material or background becomes apparent at other angles. The interference color effects due to reflected light from semi-transparent effect pigments are best observed when viewed over a dark background since the background can absorb the transmitted complementary light spectrum along with any other incident light. In this case, titanium dioxide/mica pigment with blue interference color would appear to flop between lustrous blue and black when the angle is changed. With a white background, the complementary transmitted light spectrum can diffusely scatter and reemerge to the observer, thus resulting in a less chromatic response. In this case, titanium dioxide/mica pigment with blue interference color would appear to flop between a less brilliant blue and pale yellow when the angle is changed. With a background of a different color, the background color can be hidden at the special angle, but apparent at other angles. In this case, a variety of flip-flop effects can be generated. In addition, curved surfaces can accentuate the appearance of the article, since both effects can be observed across the article at the same time.

Although a black background can improve the appearance of titanium dioxide/mica effect pigments, the interference color effects can be limited due to the inhomogeneous and impure nature of the mica used as the platelet substrate. Not wishing to be bound be theory, two general approaches have been used to improve upon the interference color effects of mica coated with a single layer of titanium dioxide (this structure is actually 3 layers—A/B/A, where B=mica, A=titanium dioxide). First, additional layers of alternating refractive index and suitable layer thicknesses can be added to the A/B/A structure such that the final structure has architecture of A/C/A/B/A/C/A where C=silicon dioxide, B=mica, and A=titanium dioxide. The additional interfaces created by the multilayered structure can contribute increased reflectivity and higher chroma versus a three-layer A/B/A structure. The second approach relies upon improving the quality of the substrate used to manufacture the effect pigment platelets. The thickness variation is relatively high for the mica platelets produced via commercial grinding and classification processes. Additionally, the mica platelets suffer from surface imperfections which can result in diffuse scattering. Natural mica also can contain iron impurities which impart a yellow mass tone to the effect pigment. Synthetic platelets based on borosilicate glass, alumina or silicon dioxide can improve the achievable color flop effects such as high chroma (color purity) and sparkle due to their smooth surfaces, uniform thickness, and no mass tone due to elemental impurities.

Color travel/goniochromatic effects are defined by the ability of the article to change color with angle of observation (i.e. green to purple, gold to purple, blue to violet, red to blue). Not wishing to be bound by theory, highly transparent special effect pigments which display color travel/goniochromatic effects can be generated a number of ways. In general, for most substrates including mica, borosilicate glass, alumina and silicon dioxide, increasing the number of layers to the base A/B/A structure can create color travel/goniochromatic effects if the layer thicknesses and refractive index differences are suitably chosen. A commercial example of this is the Firemist® Colormotion product line from BASF Corporation which relies on a 7-layer structure starting from a borosilicate platelet substrate followed by alternating TiO₂/SiO₂/TiO₂ on either side of the substrate. Alternatively, substrates such as silicon dioxide which are synthetically produced with uniform and controllable thickness can create color travel/goniochromatic effects with only a 3-layer A/B/A structure where A=TiO₂ and B=SiO₂. A commercial example of this is the Colorstream® product line from Merck KGaA (Darmstadt, Germany).

Effect pigments can have a particle size, in the longest dimension, from about 1 μm to about 200 μm, from about 2 μm to about 150 μm, from about 3 μm to about 100 μm, from about 4 μm to about 75 μm, and/or from about 5 μm to about 5 μm. The effect pigments can have a thickness less than 5 μm, less than 3 μm, less than 1 μm, less than 800 nm, less than 700 nm, and/or less than 600 nm. The effect pigments can have a thickness from about 25 nm to about 5 μm, from about 100 nm to about 3 μm, from about 150 nm to about 1 μm, from about 200 nm to about 700 nm, from about 250 nm to about 600 nm, and/or from about 300 nm to about 560 nm. The dimensions of the effect pigments can be determined by the Platelet Dimensions Test Method, described hereafter.

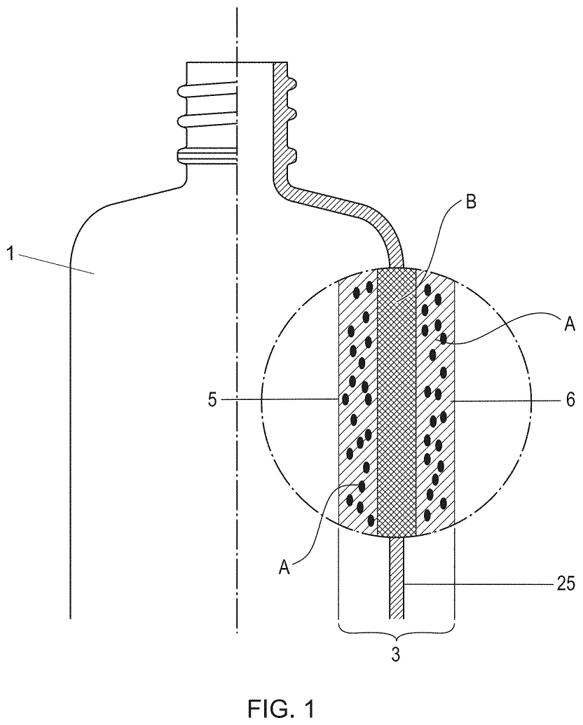

FIG. 1 shows hollow article 1, in this example the hollow article is a container, specifically a bottle. The hollow article 1 includes hollow body 25 defined by wall 3 having an inner surface 5 and an outer surface 6. As shown in the enlarged cross-section, article wall 3 has three layers. The wall can be formed without adhesives (or substantially free of adhesives) by ISBM. The skin layers (A) can comprise the effect pigments. The core layer (B) can be opaque. When the core is a separate, opaque layer, the core can absorb the transmitted complementary colors and can allow enhanced colors and/or brilliant angle dependent colors to be observed. The core can be any color. If a dark or black color is placed behind the effect pigment, this absorbs much of the transmitted light. If a white or light color is placed behind the effect pigment the complementary transmitted light spectrum can diffusely scatter and reemerge to the observer, thus resulting in a less chromatic response, as compared to the black or dark color core. However, even with an opaque white core there is still more chromatic response than with an opaque monolayer bottle.

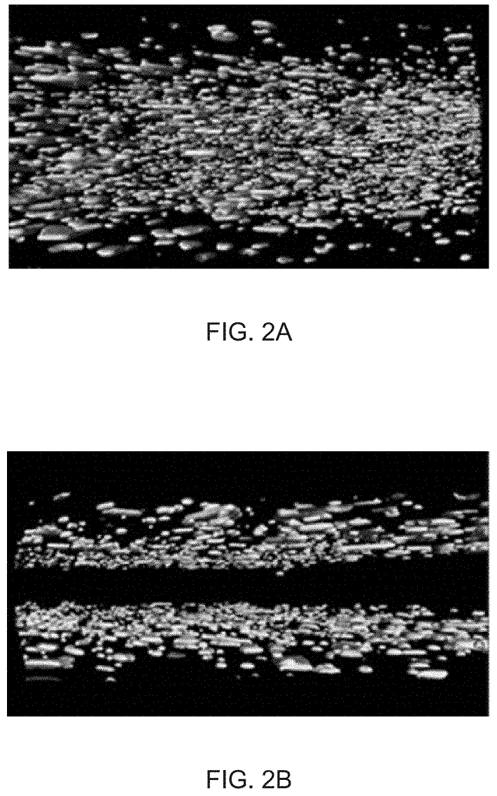

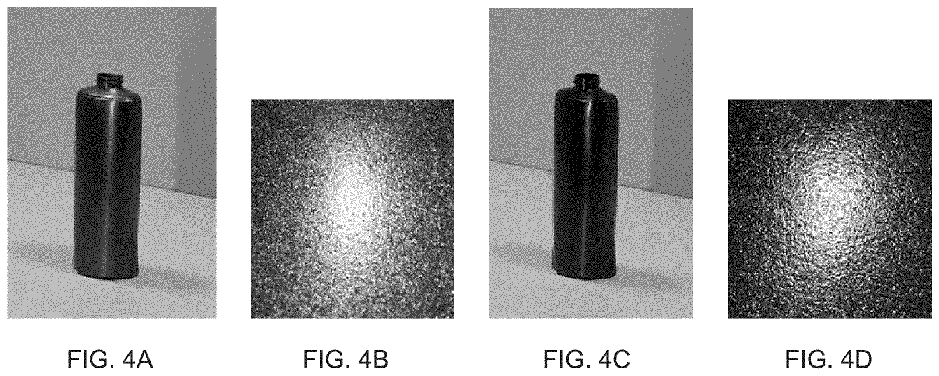

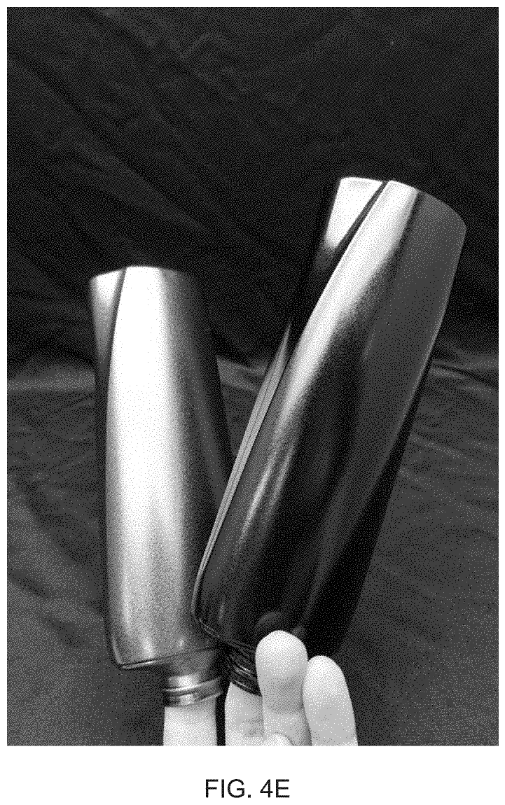

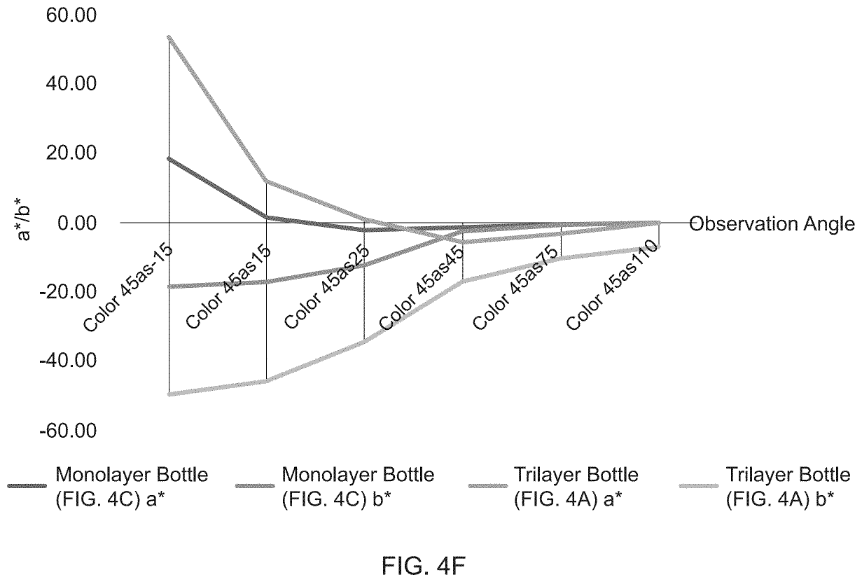

FIG. 2A shows a micro-CT rendered image of a cross-sectional view from the panel wall of a monolayer PET bottle with effect pigments. FIG. 2B shows a micro-CT rendered image of a cross-sectional view from a panel wall of a PET bottle with three layers. In FIG. 2B, the effect pigments are in the skin layers that form the outer surface and the inner surface of the bottle and the core layer is free of (or substantially free of) effect pigments. The examples in FIGS. 2A and 2B both have the same weight percent pigment loading across the entire wall: 2% opaque black masterbatch and 3.6% effect pigment masterbatch. However, in the trilayer structure in FIG. 2B, the effect pigment is only in the skin layers and is therefore the platelets are more densely packed and with a majority of the platelets in closer proximity to the outer surface of the bottle than the monolayer counterpart of FIG. 2A. The bottle in FIG. 2A corresponds to the bottle of FIGS. 4C-D and accompanying text and the bottle in FIG. 2B corresponds to FIGS. 4A-B and accompanying text, discussed hereafter.

The skin layers can have a from about 0.1 wt. % to about 6 wt. %, from about 0.3 wt. % to about 4 wt. %, and/or from about 0.5 wt. % to about 2 wt % effect pigment.

The core layer(s) can have from about 0.1 wt. % to about 6 wt. %, from about 0.3 wt. % to about 4 wt. %, and/or from about 0.5 wt. % to about 2 wt % opaque pigment and/or toner.

The article can have a total luminous transmittance of 50% or less, alternatively 40% or less, alternatively 30% or less, alternatively 20% or less, alternatively 10% or less, and alternatively 0% or less. The total luminous transmittance can be from about 0% to about 50%, alternatively from about 0% to about 40%, alternatively from about 0% to about 30%, alternatively from about 0% to about 20%, and alternatively from about 0% to about 10%. as measured in accordance with the Total Luminous Transmittance Test Method described hereafter.

The core layer can have a total luminous transmittance of less than or equal to 50%, alternatively less than or equal to 40%, alternatively less than or equal to 30%, alternatively less than or equal to 20%, alternatively less than or equal to 10%, alternatively less than or equal to 5% as measured in accordance with Total Luminous Transmittance Test Method described hereafter. The core layer can have dark or black color with a L* of less than or equal to 50, alternatively less than or equal to 40, alternatively less than or equal to 30, alternatively less than or equal to 20, alternatively less than or equal to 10, alternatively less than or equal to 5.

The core layer can be a white or light color with a L* of greater than 50, alternatively greater than or equal to 60, alternatively greater than or equal to 70, alternatively greater than or equal to 80, alternatively greater than or equal to 90, alternatively greater than or equal to 5.

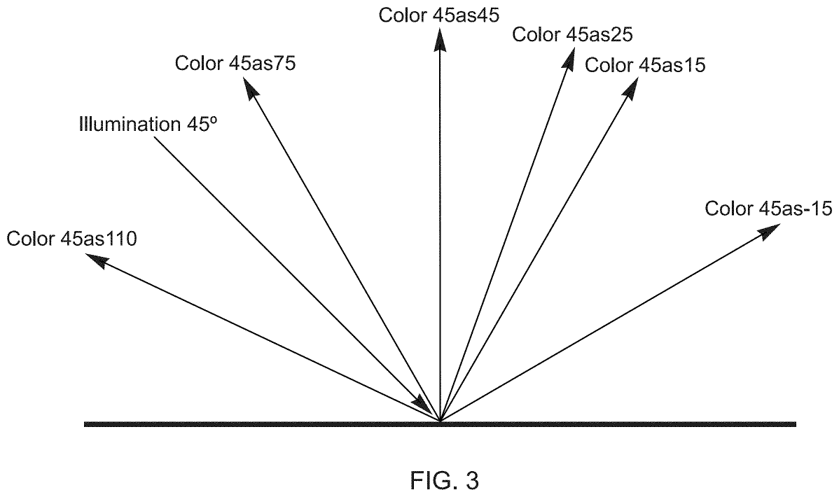

In some examples, an effect pigment, in particular a special effect pigment, can be used that can provide a goniochromatic effect (i.e. where the bottle has a color shift that is angular dependent). The magnitude of the color flop can be determined by calculating the color change, ΔE*, for the same region but between two difference detection angles such as between a steep and shallow angle of observation at (Color45as45 and Color45as−15). The greater the magnitude, the more color shift across the bottle. The measurement naming system used here is written where the first angle provided is the illumination angle as defined from the surface normal and the second angle is the aspecular detection angle. This is further described in FIG. 3.

ΔE* is mathematically expressed by the equation:

ΔE*=[(L*_{X}−L*_{Y})²+(a*_{X}−a*_{Y})²+(b*_{X}−b*_{Y})²]^{1/2}

‘X’ represents a first measurement point (e.g. Color45as45) and “Y” represents a second measurement point (e.g. Color45as−15).

Using illumination at 45°, ΔE* for −15° vs 45° detection angles for a multilayer structure with a light-colored (e.g. white) core can be greater than 18, greater than 20, greater than 25, greater than 28, greater than 30, greater than 35, and/or greater than 37. ΔE*−15° vs 45° in a multilayer structure with a light-colored (e.g. white) core can be from about 20 to about 100, from about 25 to about 80, from about 30 to about 70, and/or from about 35 to about 60.

Using illumination at 45°, ΔE*−15° vs 45° for a multilayer structure with a dark-colored (e.g. black) core can be greater than 60, greater than 75, greater than 80, greater than 85, greater than 90, greater than 95, greater than 100, and/or greater than 105. ΔE*−15° vs 45° for a multilayer structure with a dark-colored (e.g. black) core can be from about 60 to about 150, from about 75 to about 140, from about 90 to about 135, from about 95 to about 130, from about 100 to about 125, and/or from about 105 to about 120.

The ΔL* is the difference between the max and min for the following six angles: Color45as−15, Color45as15, Color45as25, Color45as45, Color45as75, and Color45as110. The ΔL* for a multilayer structure with a light-colored (e.g. white) core can be greater than 5, greater than 8, greater than 10, greater than 15, and/or greater than 20. The ΔL* for a multilayer structure with a light-colored (e.g. white) core can from about 5 to about 40, about 10 to about 35, about 15 to about 30, and/or about 20 to about 25.

The ΔL* for a multilayer structure with a dark-colored (e.g. black) core can be greater than 45, greater than 50, greater than 55, greater than 60, greater than 65, and/or greater than 70. The ΔL* for a multilayer structure with a dark-colored (e.g. black) core can from about 10 to about 100, about 25 to about 90, about 40 to about 85, and/or about 50 to about 80.

The mean C* is the mean chroma for the following six angles: Color45as−15, Color45as15, Color45as25, Color45as45, Color45as75, and Color45as110. The mean *C for a multilayer structure with a light-colored (e.g. white) core can be greater than 8, greater than 10, greater than 15, greater than 17, and/or greater than 20. The mean *C for a multilayer structure with a light-colored (e.g. white) core can be from about 7 to about 40, from about 10 to about 30, and/or from about 15 to about 25.

The mean *C for a multilayer structure with a dark-colored (e.g. black) core can be greater than 10, greater than 15, greater than 20, greater than 25, and/or greater than 30. The mean *C for a multilayer structure with a dark-colored (e.g. black) core can be from about 10 to about 50, from about 15 to about 45, from about 20 to about 40, and/or from about 25 to about 35.

It has been surprisingly found that in the articles described herein, the effect pigment particles in the skin layers can be predominantly oriented so that their face is parallel to the surface of the article. Without being bound by theory, it is believed that the ratio of oriented versus mal-oriented platelets is higher may be due to a combination of factors including the fact that the interface between each stream experiences higher shear versus similar locations in a monolayer article where the effect pigments are dispersed in the entire wall of the article which is thicker (at parity mechanical strength of the article) than the skin layers of a multilayer article. In monolayer articles the particles are less concentrated in the region of high shear thus they have more free space to rotate 360° during the injection molding process while, in a multilayer article, the skin layers, are much thinner as each skin layer only represents a portion of the total thickness of the article's wall, so that the injection molding and stretching steps provide for more optimum orientation of a larger percentage of platelet like pigment particles.

It has further been found that the tendency for the platelet effect pigments to orient parallel to the surface of the article persist even when the article is irregularly shaped. As such, the shape of the article can be further used to modify the visual effects generated by the article from the point of view of a person viewing the article, depending on the orientation of the article when being viewed.

The average panel wall thickness can be from about 200 μm to about 5 mm, alternatively from about 250 μm to about 2.5 mm, alternatively from about 300 μm to about 2 mm, alternatively from about 350 μm to about 1.5 mm, alternatively from about 375 μm to about 1.4 mm, and alternatively from about 400 μm to about 1 mm. The average panel wall thickness can be determined using the Local Wall Thickness method, described hereafter. The average local wall thickness can vary by less than 20% across the volume, alternatively less than 15%, alternatively less than 10%, and alternatively less than 10%.

The layer thickness of the skin layer comprising the outer surface and/or the skin layer comprising the inner surface and/or the core can be from about 50 μm to about 800 μm, alternatively from about 75 μm to about 600 μm, alternatively 85 μm to about 500 μm, alternatively 100 μm to about 450 μm, and alternatively from about 120 μm to about 250 μm.

The skin layer comprising the outer surface of the article can be thicker than the other layers, including the skin layer comprising the inner surface of the article. The skin layer comprising the outer surface can be 10% greater than the skin layer comprising the inner surface, 20% greater, 25% greater, 30% greater, 40% greater, and/or 50% greater. The skin layer comprising the outer surface can be twice the thickness of the skin layer comprising the inner surface, three times greater, four times greater, and/or five times greater. The thickness of the layers can be determined using the Layer Thickness Method, described herein. More details on biasing the layers is found in U.S. application Ser. No. 16/381,125 and U.S. application Ser. No. 16/158,841.

The article can feel smooth and can have a location with a Root Mean Square Roughness, Sq, of less than 50 μin (1.27 μm), less than 45 μin (1.12 μm), less than 40 μin (1.016 μm), less than 35 μin (0.89 μm), and/or less than 32 μin (0.8128 μm). The article can have a Root Mean Square Roughness, Sq, from about 20 μin (0.508 μm) to about 42 μin (1.0668 μm), from about 25 μin (0.635 μm) to about 40 μin (1.016 μm), from about 28 μin (0.7112 μm) to about 38 μin (0.9652 μm), and/or from about 30 μin (0.762 μm) to about 36 μin (0.9144 μm). The Root Mean Square Roughness, Sq, can be measured by the Root Mean Square Roughness, Sq, Measurement Method, as described hereafter.

The article may comprise more than 50% wt., preferably more than 70% wt., more preferably more than 80% wt, even more preferably more than 90% wt. of a thermoplastic resin, selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBCT), acrylonitrile styrene (AS), styrene butadiene copolymer (SBC), or a polyolefin, for example one of low-density polyethylene (LDPE), linear low-density polyethylene (LLPDE), high-density polyethylene (HDPE), propylene (PP), polymethylpentene (PMP), liquid crystalline polymer (LCP), cyclic olefin copolymer (COC), and a combination thereof. Preferably, the thermoplastic resin is selected from the group consisting of PET, HDPE, LDPE, PP, PVC, PETG, PEN, PS, and a combination thereof. In one example, the thermoplastic resin can be PET.

Recycled thermoplastic materials may also be used, e.g., post-consumer recycled polyethylene terephthalate (PCRPET); recycled polyethylene terephthalate (rPET) including post-industrial recycled PET, chemically recycled PET, and PET derived from other sources; regrind polyethylene terephthalate.

The thermoplastic materials described herein may be formed by using a combination of monomers derived from renewable resources and monomers derived from non-renewable (e.g., petroleum) resources. For example, the thermoplastic resin may comprise polymers made from bio-derived monomers in whole, or comprise polymers partly made from bio-derived monomers and partly made from petroleum-derived monomers.

The thermoplastic resin used herein could have relatively narrow weight distribution, e.g., metallocene PE polymerized by using metallocene catalysts. These materials can improve glossiness, and thus in the metallocene thermoplastic execution, the formed article has further improved glossiness. Metallocene thermoplastic materials can, however, be more expensive than commodity materials. Therefore, in an alternative embodiment, the article is substantially free of the expensive metallocene thermoplastic materials.

The core layer and the skin layers can comprise the same or different thermoplastic resins. The skin layers and core layer can be based on the same type of thermoplastic resin (e.g. PET), this can allow a better interpenetration of the layers at the interface due to their chemical compatibility and a more robust wall. For “based on the same type of resin” it is meant that the skin layers and core layers can contain at least 50%, at least 70%, at least 90%, and/or at least 95% of the same type of resin. For “same type” of resin it is intended resin from the same chemical class i.e. PET is considered a single chemical class. For example, two different PET resins with different molecular weight are considered to be of the same type. However, one PET and one PP resin are NOT considered of the same type. Different polyesters are also not considered of the same type.

The skin layers and core layers may be formed by the same thermoplastic resin (e.g. PET) and may be different only for the type of colorants and pigments (including effect pigments and/or colored pigments) added.

The skin layers and core can comprise similar resins such as identical grades of PET, dissimilar grades of PET, or virgin PET/recycled PET (rPET). The use of r-PET is desirable due to decreased cost and sustainability reasons. The skin and core layers can also comprise different resins which can alternate within the article such as PET/cyclic olefin copolymer, PET/PEN, or PET/LCP. The resin pair is chosen to have optimal properties such as appearance, mechanical, and gas and/or vapor barrier.

The article can comprise at least three layers in one or multiple regions. The region(s) formed by the three layers can comprise more than about 60%, more than about 80%, more preferably more than 90%, and/or more than 95%, of the article weight. The region(s) formed by the three layers can comprise substantially the entire length of the article and/or the entire length of the article.

The articles can comprise one or more sub-layers with various functionalities. For instance, an article may have a barrier material sub-layer or a recycled material sub-layer between an outer thermoplastic layer and an inner thermoplastic layer. Such layered containers can be made from multiple layer preforms according to common technologies used in the thermoplastic manufacturing field. Barrier material sub-layers and recycled material sublayers can be used in the core layer and/or an additional C-layer. In one example, the article wall can comprise an inner surface comprising a skin layer, adjacent to this skin layer can be a core, adjacent to the core can be a C-layer, adjacent the C-layer can be another core, and adjacent to the core can be skin layer comprising an outer surface.

The article can contain, in any of its layers as long as the required properties of the layer are maintained, additives typically in an amount of from about 0.0001% to about 9%, from about 0.001% to about 5%, and/or from about 0.01% to about 1%, by weight of the article. Non-limiting examples of the additives can include filler, cure agent, anti-statics, lubricant, UV stabilizer, anti-oxidant, anti-block agent, catalyst stabilizer, nucleating agent, and a combination thereof.

The core and/or the skin layers can contain opacifying pigments. Opacifying pigments can include opacifiers, opaque absorption pigments, and combinations thereof. The skin layer comprising the outer surface of the article can be free of or substantially free of opacifying pigments to avoid diminishing the effect of the effect pigments.

Non-limiting examples of opacifiers can include titanium dioxide, calcium carbonate, silica, mica, clays, minerals and combinations thereof. Opacifiers can be any domain/particle with suitably different refractive index from the Thermoplastic Materials (e.g. PET, which can include poly(methyl methacrylate), silicone, liquid crystalline polymer (LCP), polymethylpentene (PMP), air, gases, etc.). Additionally, opacifiers can have the appearance of being white due to scattering of light or black due to absorption of light as well as shades in between as long as they block the majority of light from being transmitted to the layer underneath. Non-limiting examples of black opacifying pigments include carbon black and organic black pigments such as Paliogen® Black L 0086 (BASF).

Opaque absorption pigments can include particles that provide color and opacity to the material in which they are present. Opaque absorption pigments can be inorganic or organic particulate materials. All absorption pigments can be opaque if their average particle size is sufficiently large, typically larger than 100 nm, alternatively larger than 500 nm, alternatively larger than 1 micrometer, and alternatively larger than 5 micrometers. Absorption pigments can be organic pigments and/or inorganic pigments. Non-limiting examples of organic absorption pigments can include azo and diazo pigments such as azo and diazo lake, Hansa, benzimidazolones, diarylides, pyrazolones, yellows and reds; polycyclic pigments such as phthalocyanines, quinacridones, perylenes, perinones, dioxazines, anthraquinones, isoindolins, thioindigo, diaryl or quinophthalone pigment, Aniline Black, and combinations thereof. Non-limiting examples of inorganic pigments can include titanium yellow, iron oxide, ultramarine blue, cobalt blue, chromic oxide green, Lead Yellow, cadmium yellow and cadmium red, carbon black pigments, mixed metal oxides, and combinations thereof. The organic and inorganic pigments can be used singly or in combination.

Furthermore, the articles described herein can be less susceptible to delamination as compared to other articles, including monolayer and multilayer articles. Delamination is a constant problem in manufacturing blow molded multilayer hollow articles, such as bottles and containers. Delamination can occur immediately or over time due to the mechanical handling of the container, to thermal stress or mechanical stress. It manifests typically as bubbles (which is actually the separation of the two layers at the interface which can see by a bubble-like appearance) on the container surface but can also be at the origin of container failure. Without being bound by theory, we believe that the parallel flow co-injection, due to a prolonged contact of the materials of the various layers still in molten or partially molten state, leads to the formation of an interface region between the layers wherein the layers are slightly interpenetrated at an interface. The interface region generates a good adhesion between the layers and thus makes it much more difficult to separate them.

The presence and thickness of the interfaces between the skin layers and the core (also referred to as the tie layer) was determined by the Tie Layer Thickness Method, described hereafter. The thickness of the interface is the distance normal to the interface over which the composition of the unique pigment, additive or resin is changing between the maximum concentration and minimum concentration.

The thickness of the interfaces (i.e. the tie layer or transition layer or area of interpenetration) can be from about 500 nm to about 125 μm, alternatively 1 μm to about 100 μm, alternatively from about 3 μm to about 75 μm, alternatively from about 6 μm to about 60 μm, alternatively from about 10 μm to about 50 μm, as determined by the Tie Layer Thickness Method, described hereafter.

These multilayer articles can have improved resistance to delamination not only with respect to articles obtained by blow molding of preforms made using step flow co-injection or overmolding, but even with respect to articles obtained from monolayer preforms. In other words, the interface layer appears to further strengthen the article wall with respect to a monolayer execution. Delamination resistance is evaluated measuring the Critical Normal Load, as described hereafter. A higher Critical Normal Load indicates a higher delamination resistance.

The articles can have a critical normal load of greater than or equal to 50N, greater than or equal to 60N, greater than or equal to 70N, greater than or equal to 80 N, greater than or equal to 90 N, greater than or equal to 95 N, greater than or equal to 100 N, greater than or equal to 104 N, greater than or equal to 105 N, greater than or equal to 110 N, and/or greater than or equal to 120 N. The articles can have a critical normal load of from about 50 N to about 170 N, alternatively from about 80 N to about 160 N, alternatively from about 90 N to about 155 N, and alternatively from about 100 N to about 145 N. The critical normal load can be measured by the Critical Normal Load, using the method described hereafter.

Another aspect the present invention relates to a hollow preform which can be blow molded to make an article as described above. A hollow preform can include a wall wherein the wall has an inside surface and an outside surface, the preform wall being formed in at least one region by three layers, two preform skin layers that include the inside surface of the wall region and the outside surface of the wall region and a preform core layer located between the two preform skin layers. These three layers together make up the entire wall of the preform in that region. The preform can be made by parallel coinjection of two or more streams and wherein one or more streams make up layer the skin layers and the remaining streams make up the core layer, wherein the skin layers include the effect pigment and the core layer can be opaque and can include opacifiers.

As apparent to a skilled person, such a preform once blow molded will form an article according to the invention having skin and core layers, wherein the layers of the preform will form the corresponding layers of the article i.e. the preform skin layers will form the skin layers of the article and the preform core layer will form the core layer of the article.

A preform suitable for blow molding can be formed by the following steps:
a) providing a co-injection mold for making a preform
b) co-injecting at essentially the same time (parallel co-injection) two or more streams of molten resin thus forming a complete preform as described above, wherein one or more streams make the preform skin layers with effect pigments and an opaque preform core layer; optionally additional streams can be added forming one or more C-layers.

A preform obtained with this method can be subsequently blow molded by IBM or ISBM, in particular the articles can be made according to ISBM. Articles made using ISBM process (as well as their respective preforms made via injection molding) can be distinguished from similar articles made using different process e.g. extrusion blow molding, for the presence of a gate mark, i.e. a small raised dot which indicates the “gate” where the injection took place. Typically, in the case of container and bottles, the “gate mark” is present at the bottom of the article.

### EXAMPLES

FIG. 4A is a trilayer bottle with Firemist® Colormotion Blue Topaz 9G680D special effect pigment (available from BASF) in the skin layers and opaque black pigment in the core and FIG. 4B is a magnified view of the outer surface of the wall of the of the trilayer bottle in FIG. 4A. FIG. 4C is a monolayer bottle where the opaque black pigment and special effect pigment are mixed and FIG. 4D is a magnified view of the outer surface of the wall of the monolayer bottle in FIG. 4C. There is equivalent loading of the special effect pigment and the opaque black pigment for both bottles and the total let-down ratio (LDR) in each article is 3.6% for the effect pigment masterbatch and 2.0% for the opaque black masterbatch. FIG. 4E shows a comparison of the trilayer bottle in FIG. 4A and the monolayer bottle in FIG. 4C. The figures show that the trilayer bottle of FIG. 4A has a rich goniochromatic optical response, as compared to the monolayer bottle of FIG. 4C.

The angle dependence color was measured to compare the trilayer bottle with an opaque black core layer of FIG. 4A with the monolayer bottle where the effect pigment and opaque black pigment are co-mixed of FIG. 4C. FIG. 4F is a graph showing detection angle vs. a* or b* values and Table 1 shows the a* and b* change as a function of viewing angle for trilayer bottle of FIG. 4A and the monolayer bottle of FIG. 4C. As shown in FIG. 4F and Table 1, both a* and b* change as a function of viewing angle.

TABLE 1

| | Monolayer | Trilayer | Monolayer | Trilayer |
|---|---|---|---|---|
| | bottle | bottle | bottle | bottle |
| | (FIG. 4C) | (FIG. 4A) | (FIG. 4C) | (FIG. 4A) |
| | a* | a* | b* | b* |
| Color45as−15 | 18.50 | 53.78 | −18.15 | −49.39 |
| Color45as15 | 1.68 | 11.82 | −16.99 | −45.84 |
| Color45as25 | −2.07 | 0.99 | −12.23 | −34.49 |
| Color45as45 | −1.18 | −5.46 | −2.34 | −17.09 |
| Color45as75 | 0.11 | −2.90 | −0.20 | −9.96 |
| Color45as110 | 0.34 | −0.08 | −0.01 | −6.93 |

Table 2 shows the C* and L* change as a function of viewing angle for trilayer bottle of FIG. 4A and the monolayer bottle of FIG. 4C. Table 2, shows that C* and L* both change as a function of viewing angle. The mean C* across the six viewing angles for the monolayer bottle (FIG. 4C) is 9.8 and the mean C* across the six viewing angles for the trilayer bottle (FIG. 4A) is 31.7, which indicates that the chroma is significantly more intense across all the viewing angles for the trilayer bottle. L* is the greatest at the angle Color45as−15 for both the monolayer and trilayer bottles, and at this angle of highest brightness, the trilayer bottle has a much higher C*. The maximum ΔL* across the six viewing angles for the monolayer bottle (FIG. 4C) is 44.5 and maximum ΔL* across the six viewing angles for the trilayer bottle (FIG. 4A) is 71.6, which indicates that the lightness varies more significantly across the viewing angles for the trilayer bottle.

TABLE 2

| | Monolayer | Trilayer | Monolayer | Trilayer | | |
|---|---|---|---|---|---|---|
| | bottle | bottle | bottle | bottle | C* Ratio, | ΔC* |
| | (FIG. 4C) | (FIG. 4A) | (FIG. 4C) | (FIG. 4A) | Trilayer/ | (Trilayer vs. |
| | C* | C* | L* | L* | Monolayer | Monolayer) |
| Color45as−15 | 25.9 | 73.0 | 45.2 | 77.7 | 2.8 | 47.1 |
| Color45as15 | 17.1 | 47.3 | 29.7 | 68.4 | 2.8 | 30.3 |
| Color45as25 | 12.4 | 34.5 | 14.0 | 40.5 | 2.8 | 22.1 |
| Color45as45 | 2.6 | 17.9 | 3.1 | 19.8 | 6.8 | 15.3 |
| Color45as75 | 0.2 | 10.4 | 1.3 | 10.0 | 44.8 | 10.1 |
| Color45as110 | 0.3 | 6.9 | 0.8 | 6.1 | 20.5 | 6.6 |

Table 3 shows the color flop magnitude (ΔE*) for Color45as−15 versus Color45as45 of the trilayer bottle with an opaque black core layer of FIG. 4A with the monolayer bottle where the effect pigment and opaque pigment are co-mixed of FIG. 4C. Table 3 confirms that there is a significant color flop in the trilayer bottle of FIG. 4A, especially as compared to FIG. 4C.

TABLE 3

| | Monolayer bottle (FIG. 4C) | Trilayer bottle (FIG. 4A) |
|---|---|---|
| ΔE* | 47 | 89 |

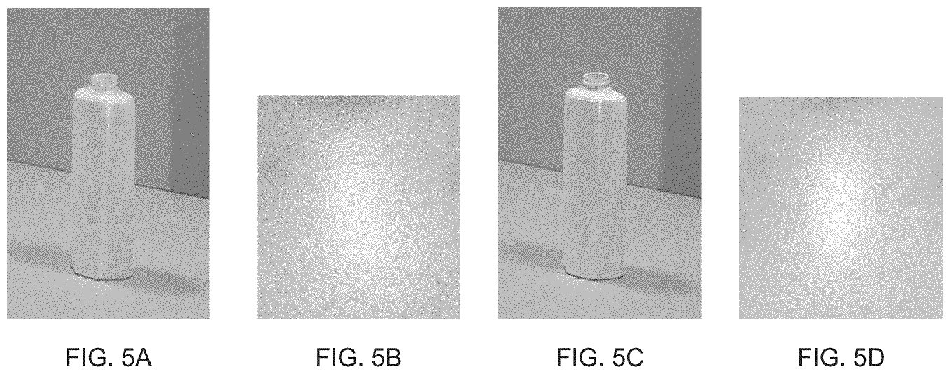

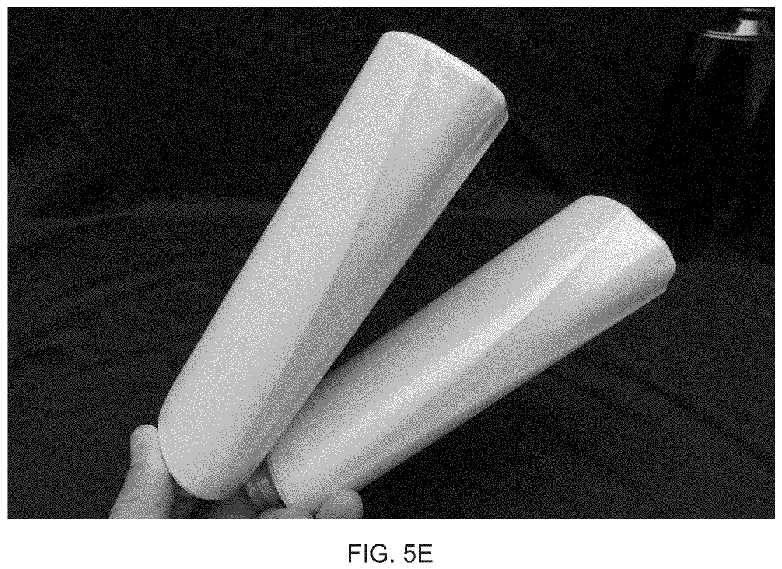

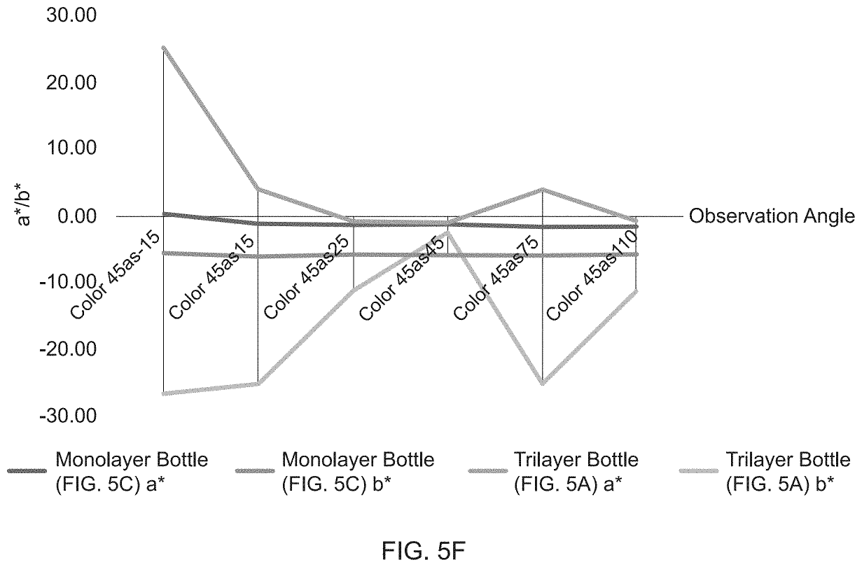

FIG. 5A is a trilayer bottle with Firemist® Colormotion Blue Topaz 9G680D special effect pigment (available from BASF) in the skin layers and opaque white pigment in the core and FIG. 5B is a magnified view of the outer surface of the wall of the of the trilayer bottle in FIG. 5A. FIG. 5C is a monolayer bottle where the opaque white pigment and special effect pigment are mixed and FIG. 5D is a magnified view of the outer surface of the wall of the monolayer bottle in FIG. 5C. There is equivalent loading of the special effect pigment and the opaque white pigment for both bottles and the total LDR in each article is 3.6% for the effect pigment masterbatch and 2.0% for the opaque black masterbatch. FIG. 5E shows comparison of the trilayer bottle in FIG. 5A and the monolayer bottle in FIG. 5C. The figures show that the trilayer bottle of FIG. 5A has a rich pearlescent finish, as compared to the flat finish monolayer bottle of FIG. 5C.

The angle dependence color was measured to compare the trilayer bottle with an opaque white core of FIG. 5A with the monolayer bottle where the effect pigment and opaque black pigment are co-mixed of FIG. 5C. FIG. 5F is a graph showing detection angle vs. a* or b* values and Table 4 shows the a* and b* change as a function of viewing angle for trilayer bottle of FIG. 4A and the monolayer bottle of FIG. 5B.

TABLE 4

| | Monolayer | Trilayer | Monolayer | Trilayer |
|---|---|---|---|---|
| | bottle | bottle | bottle | bottle |
| | (FIG. 5C) | (FIG. 5A) | (FIG. 5C) | (FIG. 5A) |
| | a* | a* | b* | b* |
| Color45as−15 | 0.23 | 25.22 | −5.63 | −26.72 |
| Color45as15 | −1.19 | 3.93 | −6.12 | −25.19 |
| Color45as25 | −1.39 | −0.86 | −5.82 | −11.29 |
| Color45as45 | −1.44 | −1.00 | −5.97 | −2.45 |
| Color45as75 | −1.65 | 3.93 | −5.93 | −25.19 |
| Color45as110 | −1.66 | −0.86 | −5.76 | −11.29 |

Table 5 shows the C* and L* change as a function of viewing angle for trilayer bottle of FIG. 5A and the monolayer bottle of FIG. 4C. Table 5, shows that C* and L* both change as a function of viewing angle. The mean C* across the six viewing angles for the monolayer bottle (FIG. 5C) is 6.0 and the mean C* across the six viewing angles for the trilayer bottle (FIG. 4A) is 18.8, which indicates that the chroma is more intense across the viewing angles for the trilayer bottle. The ΔL* across the six viewing angles for the monolayer bottle (FIG. 4C) is 4.4 and ΔL* across the six viewing angles for the trilayer bottle (FIG. 4A) is 23.2, which indicates that the lightness varies more significantly across the viewing angles for the trilayer bottle. L* does not vary significantly for the monolayer bottle in FIG. 5C. L* is the greatest at the angle Color45as−15 for both the monolayer and trilayer bottles, and at this angle of highest brightness, the trilayer bottle has a much higher C*.

TABLE 5

| | Monolayer | Trilayer | Monolayer | Trilayer | | |
|---|---|---|---|---|---|---|
| | bottle | bottle | bottle | bottle | C* Ratio, | AC* |
| | (FIG. 5C) | (FIG. 5A) | (FIG. 5C) | (FIG. 5A) | Trilayer/ | (Trilayer vs. |
| | C* | C* | L* | L* | Monolayer | Monolayer) |
| Color45as−15 | 5.6 | 36.7 | 90.0 | 101.0 | 6.5 | 31.1 |
| Color45as15 | 6.2 | 25.5 | 90.8 | 92.3 | 4.1 | 19.3 |
| Color45as25 | 6.0 | 11.3 | 88.4 | 82.8 | 1.9 | 5.3 |
| Color45as45 | 6.1 | 2.6 | 87.8 | 78.5 | 0.4 | −3.5 |
| Color45as75 | 6.2 | 25.5 | 87.8 | 79.1 | 4.1 | 19.3 |
| Color45as110 | 6.0 | 11.3 | 85.6 | 77.8 | 1.9 | 5.3 |

Table 6 shows the color flop magnitude (ΔE*) of the trilayer bottle with an opaque white core layer of FIG. 5A with the monolayer bottle where the effect pigment and opaque pigment are co-mixed of FIG. 5C. Table 6 confirms that there is a color flop in the trilayer bottle of FIG. 5A, especially as compared to FIG. 5C.

TABLE 6

| | Monolayer bottle (FIG. 5C) | Trilayer bottle (FIG. 5) |
|---|---|---|
| ΔE* | 3 | 42 |

### TEST METHODS

When the article is a container or a bottle, the critical normal load, opacity, and goniospectrophotometry measurements were all performed on a panel wall sample that was removed from the article. Unless stated, the outside surface of the panel wall sample is tested. Samples with dimensions of 100 mm in length and about 50 mm in width are cut out from the main portion of the article wall and at last 50 mm away from shoulder/neck and base regions.

When the article does not allow taking a sample this large, shorter samples in scale 1:2 width:length may be used as detailed further below. For containers and bottles, the sample is preferably removed from the label panel of the bottle at least 50 mm away from shoulder/neck or base regions. The cutting is done with a suitable razor blade or utility knife such that a larger region is removed, then cut further down to suitable size with a new single edge razor blade.

The samples should be flat if possible or made flat by using a frame maintaining the sample flat at least in the region where the test is done. It is important that the sample is flat to determine the Critical Normal Load, Root Mean Square Roughness, Sq, Total Luminous Transmittance, and Goniospectrophotometry.

### Critical Normal Load (N) and Scratch Depth at Region of Failure

If the sample readily delaminates upon removal from the bottle, the sample is given a score of 0 N for the “Critical Normal Load.” For samples which remain intact, they are subjected to scratch-induced damage using a Scratch 5 from Surface Machine Systems, LLC according to Scratch Test Procedures (ASTM D7027-13/ISO 19252:08) using a 1 mm diameter spherical tip, Initial Load: 1 N, End Load: 125 N, Scratch Rate: 10 mm/s, and Scratch Length of 100 mm. For samples smaller than 100 mm, the Scratch Length can be decreased while keeping the initial and end loads the same. This provides an estimate of the Critical Normal Load. Using this estimate, additional samples can be run over a narrower load range to provide more accurate determination of the Critical Normal Load.

Scratch-induced damage is performed on both sides of the sample corresponding to the inner and outer surface of the bottle. It is critical that the sample is affixed to the sample stage by the use of foam-based double-sided tape such as Scotch® Permanent Mounting Tape by 3M (polyurethane double-sided high-density foam tape with acrylic adhesive having a total thickness of about 62 mils or 1.6 mm, UPC #021200013393) on the underside of the sample. All samples are cleaned with compressed air before the scratch test.

The Point of Failure is visually determined after completing the scratch test as the distance across the length of the scratch at which the onset of visible delamination occurs. Delamination introduces an air gap between layers which is visible to the naked eye or with assistance of a stereomicroscope by one skilled in the art. as. This is validated based on a minimum three scratches per each side of the sample (defined as the cut out from bottle above) with a standard deviation of 10% or less. The side with lower Critical Normal Load is reported as the result of this method. The Scratch Depth at Region of Failure is measured according to ASTM D7027 across the scratch location at the point which the onset of delamination occurs. The Critical Normal Load (N) is defined as the normal load recorded at the location determined to be the Point of Failure. A Laser Scanning Confocal Microscope (KEYENCE VK-9700K) and VK-X200 Analyzer Software is used to analyze scratch-induced damage including the Point of Failure, Scratch Width, and Scratch Depth.

### Goniospectrophotometry

ΔE* is mathematically expressed by the equation:

ΔE*=[(L*_{X}−L*_{Y})²+(a*_{X}−a*_{Y})²+(b*_{X}−b*_{Y})²]^{1/2}

‘X’ represents a first measurement point (e.g. Color45as45) and “Y” represents a second measurement point (e.g. Color45as−15).

Reflected color characteristics of L*, a*, b*, C* and h° are measured using a Multi-Angle Spectrophotometer such as the MA98 from X-Rite Incorporated in accordance with ASTM E 308, ASTM E 1164, ASTM E 2194, and ISO 7724. The samples are placed over a white background which is referred to as “Base White”. The “Base White” is the white area from the X-Rite Grey Scale Balance Card (45as45 L*a*b* 96.2−0.8 3.16).

The samples are measured with CIE Standard Illuminant D65/10° illumination. The measurement naming system used here is written where the first angle provided is the illumination angle as defined from the surface normal and the second angle is the aspecular detection angle. This is further described in FIG. 3. A region is measured on the outside panel wall is measured 3 times and the average reading is recorded.

When a color is expressed in CIELAB (L*a*b*), L* defines lightness, a* denotes the red/green value ((+a=red, −a=green), b* the yellow/blue value ((+b=yellow, −b=blue), C* defines Chroma, and h° defines Hue angle. Chroma describes the vividness or dullness of a color where + is brighter and − is duller. Chroma is also known as saturation. Lightness is difference in lightness/darkness value where + is “lighter” and − is “darker. L* represents the darkest black at L*=0, and the brightest white at L*=100. Hue is an attribute of a color by virtue of which it is discernible as red, green, etc., and which is dependent on its dominant wavelength, and independent of intensity or lightness. The ΔL* is the difference between the max and min L* for the following six angles: Color45as−15, Color45as15, Color45as25, Color45as45, Color45as75, and Color45as110.

### Local Wall Thickness

Wall thickness at specific locations was measured using an Olympus Magna-Mike® 8600 using a ⅛″ dia. target ball. Three measurements were taken at each location and the mean was calculated to determine the local wall thickness.

The average local wall thickness was determined by determining the local wall thickness as described above across the length of the article or panel and then calculating the mean. The thickness near the shoulder and near the base is excluded from the average local wall thickness.

### Total Luminous Transmittance

Total Luminous transmittance is measured using a benchtop sphere spectrophotometer such as a Ci7800 (X-Rite) using D65 illumination. The total luminous transmittance is measured in accordance with ASTM D1003. % Opacity can be calculated from 100−% total luminous transmittance. A region is measured on the outside panel wall is measured 3 times and the average reading is recorded.

### Root Mean Square Roughness, Sq, Measurement Method

Root Mean Square Roughness, Sq, is measured using a 3D Laser Scanning Confocal Microscope such as a Keyence VK-X200 series microscope available from KEYENCE CORPORATION OF AMERICA) which includes a VK-X200K controller and a VK-X210 Measuring Unit. The instrument manufacturer's software, VK Viewer version 2.4.1.0, is used for data collection and the manufacturer's software, Multifile Analyzer version 1.1.14.62 and VK Analyzer version 3.4.0.1, are used for data analysis. The manufacturer's image stitching software, VK Image Stitching version 2.1.0.0, is used. The manufacturer's analysis software is compliant with ISO 25178. The light source used is a semiconductor laser with a wavelength of 408 nm and having a power of about 0.95 mW.

The sample to be analyzed is obtained by cutting a piece of the article that includes the region to be analyzed in a size that can fit the microscope for proper analysis. If the sample is not flat, but is flexible, the sample may be held down on the microscope stage with tape or other means. If, due to the shape, flexibility or other characteristic of the sample, measurements will be more accurate when the sample is not flattened, corrections may be sued, as explained hereinbelow.

The measurement data from the sample is obtained using a 50× objective lens suitable for non-contact profilometry, such as a 50× Nikon CF IC Epi Plan DI Interferometry Objective with a numerical aperture of 0.95. The data is acquired using the acquisition software's “Expert Mode”, with the following parameters set as described he: 1) Height Scan Range is set to encompass the height range of the sample (this can vary from sample to sample depending on the surface topography of each); 2) Z-direction Step Size is set to 0.10 micrometers; 3) Real Peak Detection mode is set to “On”; and 4) Laser Intensity and Detector Gain are optimized for each sample using the autogain feature of the instrument control software. Arrays of 3×3 images are collected and stitched together for each sample resulting in a field of view of 790×575 μm (width×height); lateral resolution was 0.56 μm/pixel.

Prior to analysis, the data is subjected to the following corrections using the manufacturer's Multifile Analyzer software: 1) 3×3 median smoothing in which the center pixel of a 3×3 pixel array is replaced by the median value of that array; 2) noise removal using weak height cut (following built in algorithm in the analysis software), and 3) shape correction using waveform removal (0.5 mm cutoff). Specify the Reference Plane using the Set Area method and selecting the same area as was used for the form removal. Regions including foreign materials, artifacts of the sample harvesting process or any other obvious abnormalities should be excluded from analysis and alternative samples should be used for any sample which can't be accurately measured. The resulting value is the Root Mean Square Roughness, Sq, for the measured portion of the sample.

### Layer Thickness & Platelet Dimensions

MicroCT Scan Method

Samples of the bottles to be tested are imaged using a microCT X-ray scanning instrument capable of scanning a sample having dimensions of at least approximately 1 mm×1 mm×4 mm as a single dataset with contiguous voxels. An isotropic spatial resolution of at least 1.8 μm is required in the datasets collected by microCT scanning One example of suitable instrumentation is the SCANCO Systems model μ50 microCT scanner (Scanco Medical AG, Bratisellen, Switzerland) operated with the following settings: energy level of 55 kVp at 72 μA, 3600 projections, 10 mm field of view, 1000 ms integration time, an averaging of 10, and a voxel size of 1.8 μm. For higher resolution, suitable instrumentation includes the X-ray tomographic microscopy capability at the TOMCAT beamline of the Swiss Light Source (SLS) at the Paul Scherrer Institute (PSI), Switzerland equipped with a high-quality microscope (Optique Peter, Lentilly, France) with a 40× objective coupled to a PCO.edge 5.5 sCMOS camera (PCO, Kelheim, Germany), 20 μm thick LuAG:Ce scintillator screen and a resulting isotropic voxel size of about 0.163 μm. The beam energy is set to 15 keV with a 250 ms exposure time and for each scan about 1501 projections are acquired.

Test samples to be analyzed are prepared by cutting a rectangular piece of the plastic from the wall, preferably label panel region with an Exacto knife and then further trimming the sample to approx. 1-5 mm in width using a fine tooth Exacto saw with care to avoid causing cracks. The sample is positioned vertically with materials such as mounting foam material within a plastic cylindrical scanning tube or by affixing the sample to a brass pin (diameter of 3.15 mm) using double-sided sticky tape and/or clear nail polish lacquer. The instrument's image acquisition settings are selected such that the image intensity contrast is sensitive enough to provide clear and reproducible discrimination of the sample structures from the air and the surrounding mounting foam. Image acquisition settings that are unable to achieve this contrast discrimination or the required spatial resolution are unsuitable for this method. Scans of the plastic sample are captured such that a similar volume of each sample with its caliper is included in the dataset.

Software for conducting reconstructions of the dataset to generate 3D renderings is supplied by the scanning instrument manufacturer. Software suitable for subsequent image processing steps and quantitative image analysis includes programs such as Avizo Fire 9.2 (Visualization Sciences Group/FEI Company, Burlington, Mass., U.S.A.), and MATLAB® version 9.1 with corresponding MATLAB® Image Processing Toolbox (The Mathworks Inc. Natick, Mass., U.S.A.). MicroCT data collected with a gray level intensity depth of 16-bit is converted to a gray level intensity depth of 8-bit, taking care to ensure that the resultant 8-bit dataset maintains the maximum dynamic range and minimum number of saturated voxels feasible, while excluding extreme outlier values.

Alignment of the sample surface such that it is parallel with the YZ plane of the global axis system is accomplished by one of the following ways including using a fixture for the microCT that aligns the material correctly or by using software, such as Avizo, to visually align the surface and use interpolation to resample the dataset.

The layer thickness is measured via MicroCT with image analysis where the effect pigment layer is defined as containing 95% of the pigment. The analysis is performed on a processed microCT dataset that contains a square section of material approximately 1.5 mm×1.5 mm. The dataset goes border to border in the YZ direction. It completely intersects the minimum Y border, the maximum Y border, the minimum Z border and the maximum Z border. A small non-material buffer of region will exist between the minimum X border and the maximum X border. This region will consist of air or packing material.

Layer Thickness Method

A material threshold is determined by executing Otsu's method on all the samples of interest and averaging the results. The material threshold should identify the bottle material while minimizing noise and packing material. The material threshold is applied to the aligned and trimmed dataset. Lines of voxel values, parallel to the x-axis, are acquired for every Y,Z value of the material dataset. A typical line will consist of a large continuous band of material which is the bottle. Smaller bands of material may also be present due to packing material used to hold the sample in place or due to noise. The position of the start and finish voxel of the largest band of material is recorded for each line. These positions are averaged together and give the edge of the material. The edge of the material may experience microCT diffraction artifacts caused by the sudden change in density from air to polymer. These fringe effects may bring the edge voxel values high enough to be misclassified as pigment. To eliminate this effect, the material boundary, as determined by the average start and finish position, is moved inward by 10 voxels.

With the material boundaries established, each sample is once again processed by the Ostu's method to determine a threshold for the pigments. The average of all the sample thresholds is used to segment the pigment from the material. Each dataset is thresholded with the pigment threshold to generate a pigment dataset. Pigment voxels outside the material boundary are set to zero to remove any noise and fringe effects.

The number of pigment voxels on every YZ slice is calculated within the material. The slice totals are summed to a grand total. From these summations, bounding YZ slices are defined as those which enclose 95% of the pigment material. The distances from the material boundaries to the 95% pigment boundaries is reported as the layer thicknesses.

Platelet Dimensions Method

The analysis is performed on a reconstructed voxel dataset that contains a square section of bottle material. A threshold is determined which separates the pigment platelets from the bottle material. Platelets can be enumerated in the sample using a connected components function such as the bwconncomp function available in MATLAB®. Platelets can be warped or damaged by the bottle creation process. If a platelet volume is too small for an accurate measurement, contains holes or is warped (non-planar as described below), it is ignored. Individual platelets are measured for thickness and width as described below.

First, XYZ voxel positions of the of the platelet are sent to for principle components analysis using MATLAB®'s pca function to determine the orientation of the platelet. With this information, the platelet can be reoriented such that the platelet lies nearly horizontal on the XY plane. Projecting the platelet voxels to the XY plane creates a silhouette of the platelet. This can be used to find a maximum circle in the projection which then defines a trimming template that can be used to cut the platelet into a disk shape. A Euclidian distance map (MATLAB®'s bwdist function) generated from the top of the disc is used to measure the average thickness to the bottom of the disc. This distance measurement is independent of the orientation of the platelet. If the platelet is planer (no warping), the smallest Z distance to the XY plane should be nearly constant for every XY position and the average height of the platelet measured from the smallest Z value to the largest Z value should be within 15% of the average thickness found earlier. Non-planar platelets are ignored.

The projected silhouette can be measure across its major axis width and its minor axis width using a standard imaging method for fitting ellipse available in MATLAB®'s regionprops function. This is a measure of the maximum width of the platelet and the minimum width of the platelet.

### Tie Layer Thickness (Interface Layer Thickness):

A unique additive, colorant, or resin is placed within at least one of the layers which allows either Method A or Method B to map the composition over the distance normal to the interface over which the composition of the unique additive, colorant, or resin is changing between the maximum concentration and minimum concentration.

Method A: Energy Dispersive X-Ray Spectroscopy (EDS) Mapping Method for Adjacent Layers Having Unique Elemental Composition by Virtue of the Resins (e.g. PET/Nylon) or Colorants/Additives.

Method A may be used if the bottle sample (preparation of the bottle sample is described below) will contain colorants and/or additives at or above 2 wt. % having elemental compositions which may be suitably mapped by EDS (e.g. elements higher than atomic number 3 not including carbon or oxygen). These colorants/additives can be molecular species or particulates. If they are particulate in form, they should be well dispersed such that there are about 10 or more particles within a 5 μm×5 μm×200 nm volume. Generally, the particles should be less than 500 nm in the largest dimension.

### Sample Preparation:

A piece of the bottle label panel wall at least 50 mm away from shoulder/neck or base regions measuring ˜3 cm×3 cm is extracted using a heated blade. The heated blade enables sectioning of the bottle without applying large amounts of force which may induce premature delamination. This accomplished by melting the panel wall material rather than cutting. The melted edges of the piece are removed with scissors, then the ˜3 cm×3 cm piece is further sectioned into several pieces measuring approximately 1 cm×0.5 cm, using a new sharp single edge razor blade. The cutting force is applied along the length of the piece, parallel to the layers/interfaces, rather than perpendicular to the interface to prevent smearing across the interface.

Then, the ˜1 cm×0.5 cm pieces are then hand polished, edge-on, producing a polished surface which displayed the cross-section of the bottle wall and the layered structure. The initial polishing consists of using SiC papers, with progressively smaller grit sizes (400, 600, 800, and then 1200) while using distilled water as a lubricant/coolant. The 1200 grit polished surface is then further polished, using 0.3 μm Al₂O₃ polishing media, with distilled water being used as lubricant. The polished samples are then ultrasonically cleaned in a solution of detergent+distilled water, for 1 min, followed by three additional rounds of ultrasonic cleaning in fresh distilled water, to rinse the detergent from the sample. A final ultrasonic cleaning is performed in ethanol for 2 min. The polished and cleaned samples are mounted on a SEM stub with double sided carbon tape with the edge-on side up, then coated with approximately 1020 nm of carbon, as deposited by carbon evaporator such as a Leica EM ACE600 (Leica Microsystems).

### Identification of the Approximate Interface by SEM:

Identification of the approximate interface between A/C or C/B layers is necessary in order to allow finding the interface in the dual-beam FIB. To identify the approximate interface, SEM imaging and EDS mapping is performed by a modern field emission SEM such as a FEI (Thermo Scientific®) Apreo SEM equipped with a silicon drift EDS detector (SDD) such as an EDAX Octane Elect 30 mm² SDD (EDAX Inc.). A preliminary EDS map at about 500 to 1000× magnification is collected across the cross-sectional plane to confirm the presence of the layered structure by identifying the unique elements present in each layer. The accelerating voltage is suitably set in order to ionize the most ideal electron shell of the elements of interest in order to generate an X-ray signal. USP<1181> (USP29-NF24) provides a useful reference for choosing the best operating conditions to collect the EDS signal.

The EDS map is used to show the approximate location of the interface between the layers, after which platinum fiducial markers are deposited via e-beam deposition, using a gas injection system (GIS), to mark the location of the interface. Another, EDS map is collected, with the Pt fiducial markers, to confirm their location with respect to the interface.

### Dual-Beam FIB Sample Preparation:

A thin foil sample (100-200 nm thick) is required to map the interface at suitably high resolution. The lamella is prepared using a modern dual beam FIB such as an FEI (Thermo Scientifc®) Helios 600. The interface is located in the FIB with the aid of the platinum fiducial markings. A protective platinum cap is then deposited on the area of interest at the interface in the FIB, measuring approximately 30 μm×2 μm×2 μm. This is done to protect the material, which will become the lamella sample, from unnecessary damage from the ion beam. The 30 μm dimension is oriented perpendicular to the interface such that approximately 15 μm covers one side of the interface and 15 μm covers the other side. Material is then removed from each side of the platinum cap, leaving the capped region as a lamella, measuring approximately 30 μm wide×2 μm thick×10 μm deep where the interface is oriented parallel to the 10 μm direction. The lamella is then extracted, with the aid of an Omniprobe nanomanipulation device (Oxford Instruments), and attached to a copper Omniprobe grid. The lamellar sample is then thinned, using 30 kV gallium ions, until sufficiently thin (˜500-200 nm). The newly-thinned lamellar sample is then cleaned with 5 kV gallium ions, to remove excess damage caused by the 30 kV thinning process.

### STEM Data Collection:

Scanning transmission electron microscopy (STEM) Energy Dispersive X-ray Spectroscopy (EDS) data is collected using a modern field emission TEM such as a FEI Tecnai TF-20 (Thermo Scientific®) equipped with a modern silicon drift EDS detector (SDD) such as an EDAX Apollo XLT2 30 mm² SDD detector (EDAX Inc.) with collection and analysis software such as Apex™ (EDAX Inc.). The interface region from within the foil produced as described above is mapped with EDS to display the presence and location of the elemental constituents in the two polymer layers. The size of the EDS map is about 20×10 μm where the interface is perpendicular to the 20 μm direction (“Y” direction) and parallel to the 10 μm direction (“X” direction). The “Y” and “X” directions are perpendicular or almost perpendicular to each other.

The map is collected by using between 200 to 300 kV accelerating voltage and a beam current at or between 100 pA and 1 nA to achieve SDD count rate of at least 3,000 counts per second. The map resolution is at least 256×160 pixels with a dwell time of about 200 us per pixel. About 200 frames are collected for a total map time of about 30 minutes. The elements of interest are selected and a standardless automatic ZAF analysis method such as the P/B-ZAF fundamental parameter analysis is selected to enable quantitative mapping.

### Data Processing:

The EDS map data can be displayed as color-coded images, with a unique color corresponding to each element. The intensity of the color is scaled with the concentration of the elemental species. The EDS map data is processed to display a line profile of normalized atom % by summing the X-ray counts for each element as they occur in the “Y” direction (parallel to the interface) and the summed intensities are plotted as a function of distance across the interface in the “X” direction (normal to the interface). The distance between the maximum and minimum normalized atom % (both having about zero slope across about 2-4 microns) for at least one element is defined as the interface layer thickness.

Method B: Confocal Raman Spectroscopy Mapping Method for Adjacent Layers Having Unique Spectral Characteristics by Virtue of the Resins (e.g. PET/COC) or Colorants/Additives.

2D Chemical maps or line scans are collected across the layer interface using a confocal Raman microscope (Witec A300R Confocal Raman spectrometer) equipped with a continuous laser beam, motorized x-y sample scanning stage, video CCD camera, LED white-light source, diode-pumped laser excitations from 488 nm to 785 nm, and 50× to 100× (Zeiss EC Epiplan-Neofluar, NA=0.8 or better) microscope objectives.

Samples are prepared in a similar manner as described in Method A—Sample Preparation section, however the samples are uncoated.

The sample is mounted on a glass microscope slide with edge-on side up. An area of interest near the layer interface is located with the aid of the video CCD camera using the white-light source. From the area of interest, 2D Chemical maps via spectral acquisition are acquired by focusing the laser beam at or below the surface and scanning across the layer interface in the X-Y direction with steps of 1 μm or lower, with integration time lower than 1 s at each step. The integration time should be adjusted to prevent saturation of the detector. Raman images are generated using a suitable software such as the WItec™ Project Five (Version 5.0) software using spectral features unique to each polymer layer such as peak intensities, integrated areas, peak widths, and/or fluorescence. The full Raman spectral data at each pixel in the data set is corrected for cosmic rays and baseline corrected prior to image generation. To determine intermixing between polymer layers, a cross section analysis wherein the spectral features used to generate the chemical map are followed along a line drawn across the interface including at least 10 microns within area that covers the polymer layers of interest. The defined spectral features are plotted against distance in micrometers. The interlayer mixing distance (i.e. tie layer) is defined as the distance between the maximum and minimum values of the spectral features.

### Combinations

A. A blow molded multilayer article comprising:
   a hollow body defined by a wall comprising an inner surface and an outer surface,
   the wall being formed in at least one region by 3 or more layers comprising:
      a first skin layer and a second skin layer comprising an effect pigment and a first thermoplastic resin, wherein the first skin layer comprises the outer surface of the wall in the region and the second skin layer comprises the inner surface of the wall in the region;
      a core comprising a total luminous transmittance of less than 50% is sandwiched between the two skin layers, wherein the core comprises a second thermoplastic resin;
      wherein the first thermoplastic resin and the second thermoplastic resin are the same or different.
B. The article according to Paragraph A, wherein the effect pigment comprises a special effect pigment adapted to produce at least one interference color.
C. The article according to Paragraphs A-B, wherein the core comprises a second thermoplastic resin and is substantially free of effect pigment
D. An article comprising:
   a hollow body defined by a wall comprising an inner surface and an outer surface,
   the wall being formed in at least one region by 2 or more layers comprising:
      a skin layer comprising a special effect pigment adapted to produce at least one interference color and a thermoplastic resin, wherein the skin layer comprises the outer surface of the wall in the region;
      and a core comprising a total luminous transmittance of less than 30% adjacent to the skin layers, wherein the core comprises a second thermoplastic resin and is substantially free of effect pigment;
      wherein the first thermoplastic resin and the second thermoplastic resin are the same or different.
E. The article according to Paragraphs B-D, wherein the core layer comprises a L* of greater than 50, preferably greater than or equal to 60, more preferably greater than or equal to 70, more preferably greater than or equal to 80.
F. The article according to Paragraphs B-E, the blow molded multilayer article of claim 3, comprising a ΔE*−15° vs 45° greater than 18, preferably greater than 20, more preferably greater than 25, even more preferably greater than 30.
G. The article according to Paragraphs B-F, the blow molded multilayer article of claim 3, comprising a ΔE*−15° vs 45° is from about 20 to about 100, preferably from about 25 to about 80, more preferably from about 30 to about 70, and even more preferably from about 35 to about 60.
H. The article according to Paragraphs B-G, comprising a ΔL* greater than 5, preferably greater than 10, more preferably greater than 15, even more preferably greater than 20.
I. The article according to Paragraphs B-H, comprising a ΔL* from 5 to 40, preferably 10 to 35, more preferably 15 to 30, and even more preferably 20 to 25.
J. The article according to Paragraphs B-I, comprising a mean *C greater than 8, preferably greater than 10, more preferably greater than 15, even more preferably greater than 17.
K. The article according to Paragraphs B-J, comprising a mean *C from about 7 to about 40, preferably from about 10 to about 30, more preferably from about 15 to about 25.
L. The article according to Paragraphs B-D, wherein the core layer comprises a L* of less than or equal to 50 preferably less than or equal to 40, more preferably less than or equal to 30, even more preferably less than or equal to 20.
M. The article according to Paragraphs B-D and L, comprising a ΔE*−15° vs 45° from about 150, preferably from about 75 to about 140, more preferably from about 90 to about 135, even more preferably about 95 to about 130, even more preferably about 105 to about 120.
N. The article according to Paragraphs B-D and L-M, comprising a ΔL* of greater than 45, preferably greater than 50, more preferably greater than 60, even more preferably greater than 65.
O. The article according to Paragraphs B-D and L-N, comprising a ΔL* from about 10 to about 100, preferably from about 25 to about 90, more preferably from about 40 to about 85, and even more preferably from about 50 to about 80.
P. The article according to Paragraphs B-D and L-O, comprising a mean *C greater than 10, preferably greater than 15, more preferably greater than 20, even more preferably greater than 25.
Q. The article according to Paragraphs B-D and L-P, comprising a mean *C from about 10 to about 50, preferably from about 15 to about 45, more preferably from about 20 to about 40, and even more preferably from about 25 to about 35.
R. The article according to Paragraphs A-Q, wherein the effect pigment comprises platelet-like pigments with a face wherein the pigments are primarily oriented so that the face is parallel to the outer surface of the article.
S. The article according to Paragraphs A-R, wherein the first skin layer comprises a thickness and the second skin layer comprises a thickness wherein the thickness of the first skin layer is at least 25% greater than the thickness of the second skin layer, preferably 30% greater, more preferably 40% greater, even more preferably 50% greater.
T. The article according to Paragraphs A-S, wherein the first skin layer comprises a thickness and the second skin layer comprises a thickness wherein the thickness of the first skin layer is twice the thickness of the skin layer comprising the inner surface, preferably three times greater, more preferably four times greater, and even more preferably five times greater.
U. The article according to Paragraphs A-T, wherein the article is a bottle.
V. The article according to Paragraphs A-U, wherein the article had a Critical Normal Load greater than or equal to 50 N, preferably greater than or equal to 70N, more preferably greater than or equal to 90 N, and even more preferably greater than or equal to 100 N as determined by the Critical Normal Load Test Method described herein.
W. The article according to Paragraphs A-V, wherein the first thermoplastic resin and second thermoplastic resin is selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBCT), acrylonitrile styrene (AS), styrene butadiene copolymer (SBC), low-density polyethylene (LDPE), linear low-density polyethylene (LLPDE), high-density polyethylene (HDPE), polypropylene (PP), and a combination thereof.
X. The article according to Paragraphs A-W, wherein the first thermoplastic resin and second thermoplastic resin comprises polyethylene terephthalate.
Y. The article according to Paragraphs A-X, wherein the skin layers and the core layers are slightly interpenetrated at an interface between the skin layer and the core layer.
Z. The article according to Paragraphs A-Y, wherein the interface comprises a thickness from about 500 nm to about 125 μm, preferably from about 1 μm to about 100 μm, preferably from about 3 μm to about 75 μm, even more preferably from about 6 μm to about 60 μm as determined by the Tie Layer Thickness Method described herein.
AA. The article according to Paragraphs A-Z, wherein said region formed by three layers comprises more than 90% of the article weight.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A blow molded multilayer article comprising:
a hollow body defined by a wall comprising an inner surface and an outer surface,
the wall being formed in at least one region by 3 or more layers comprising:
a first skin layer and a second skin layer comprising an effect pigment and a first thermoplastic resin, wherein the first skin layer comprises the outer surface of the wall in the region and the second skin layer comprises the inner surface of the wall in the region;
a core comprising a total luminous transmittance of less than 50% is sandwiched between the two skin layers, wherein the core comprises a second thermoplastic resin;
wherein the first thermoplastic resin and the second thermoplastic resin are the same or different.

2. The blow molded multilayer article of claim 1, wherein the effect pigment comprises a special effect pigment adapted to produce at least one interference color.

3. The blow molded multilayer article of claim 2, wherein the core layer comprises a L* of greater than 50.

4. The blow molded multilayer article of claim 3, comprising ΔE−15° vs 45° is greater than 18.

5. The blow molded multilayer article of claim 3, comprising a mean *C greater than 8.

6. The blow molded multilayer article of claim 2, wherein the core layer comprises a L* of less than or equal to 50.

7. The blow molded multilayer article of claim 6, comprising ΔE−15° vs 45° is greater than 50.

8. The blow molded multilayer article of claim 6, comprising a ΔL* of greater than 45.

9. The blow molded multilayer article of claim 1, wherein the effect pigment comprises platelet-like pigments with a face wherein the pigments are primarily oriented so that the face is parallel to the outer surface of the article.

10. The blow molded multilayer article of claim 1, wherein the first skin layer comprises a thickness and the second skin layer comprises a thickness wherein the thickness of the first skin layer is at least 25% greater than the thickness of the second skin layer.

11. The blow molded multilayer article of claim 1, wherein the article is a bottle.

12. The blow molded multilayer article of claim 1, wherein the article had a Critical Normal Load greater than 50 N.

13. The blow molded multilayer article of claim 1, wherein the first thermoplastic resin and second thermoplastic resin are selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBCT), acrylonitrile styrene (AS), styrene butadiene copolymer (SBC), low-density polyethylene (LDPE), linear low-density polyethylene (LLPDE), high-density polyethylene (HDPE), polypropylene (PP), and a combination thereof.

14. The blow molded multilayer article of claim 13, wherein the first thermoplastic resin and second thermoplastic resin comprises polyethylene terephthalate.

15. The blow molded multilayer article of claim 13, wherein the second resin comprises recycled polyethylene terephthalate.

16. The blow molded multilayer article of claim 15, wherein the first resin comprises polyethylene terephthalate.

17. The blow molded multilayer article of claim 1, wherein the skin layers and the core layers are slightly interpenetrated at an interface between the skin layer and the core layer.

18. The blow molded multilayer article of claim 1, wherein said region formed by three layers comprises more than 90% of the article weight.

19. An article comprising:
a hollow body defined by a wall comprising an inner surface and an outer surface,
the wall being formed in at least one region by 2 or more layers comprising:
a skin layer comprising a special effect pigment adapted to produce at least one interference color and a thermoplastic resin, wherein the skin layer comprises the outer surface of the wall in the region;
and a core comprising a total luminous transmittance of less than 30% adjacent to the skin layers, wherein the core comprises a second thermoplastic resin and is substantially free of effect pigment;
wherein the first thermoplastic resin and the second thermoplastic resin are the same or different.
